(19) United States
(12) Patent Application Publication
(10) Pub. No.: US 2003/0189303 A1
(43) Pub. Date: Oct. 9, 2003

(54) Platform attachment for a dolly

(76) Inventor: Paul Ciminelli, Orange City, FL (US)

Correspondence Address: Lingbeck Patent Law Office, P.O. Box 500, St.Michael, MN, 55376, US

(21) Appl. No.: 10/115,369

(22) Filed: Apr. 4, 2002

(51) Int. Cl. B62B 1/00

(52) U.S. Cl. 280/47.34; 280/47.27

(57) ABSTRACT

A platform attachment for a dolly for stabilizing and carrying heavy and large loads. The platform attachment for a dolly includes a board member being adapted to mount upon a dolly, and being generally rectangular-shaped, and having a selected thickness, and also having first and second end edges and longitudinal edges, and further having an elongate slot being disposed therethrough near the second end edge thereof and being adapted to receive a blade-like carry member of the dolly therethrough.

### BACKGROUND OF THE INVENTION

1. Field of the Invention

The present invention relates to dolly platform attachments and more particularly pertains to a new platform attachment for a dolly for stabilizing and carrying heavy and large loads.

2. Description of the Prior Art

The use of dolly platform attachments is known in the prior art. More specifically, dolly platform attachments heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 5,465,987; U.S. Pat. No. 6,053,515; U.S. Pat. No. 2,670,964; U.S. Pat. No. 3,785,669; U.S. Pat. No. 5,536,034; and U.S. Pat. No. Des. 404,871.

While these devices fulfill their respective, particular objectives and requirements, the aforementioned patents do not disclose a new platform attachment for a dolly. The prior art includes inventions having platforms which are either clipped upon the dollies or are fastened directly to the dollies.

### SUMMARY OF THE INVENTION

The general purpose of the present invention, which will be described subsequently in greater detail, is to provide a new platform attachment for a dolly which has many of the advantages of the dolly platform attachments mentioned heretofore and many novel features that result in a new platform attachment for a dolly which is not anticipated, rendered obvious, suggested, or even implied by any of the prior art dolly platform attachments, either alone or in any combination thereof. The present invention includes a board member being adapted to mount upon a dolly, and being generally rectangular-shaped, and having a selected thickness, and also having first and second end edges and longitudinal edges, and further having an elongate slot being disposed therethrough near the second end edge thereof and being adapted to receive a blade-like carry member of the dolly therethrough. None of the prior art discloses inventions where the platform can be easily slipped on and off the dolly.

There has thus been outlined, rather broadly, the more important features of the platform attachment for a dolly in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new platform attachment for a dolly which has many of the advantages of the dolly platform attachments mentioned heretofore and many novel features that result in a new platform attachment for a dolly which is not anticipated, rendered obvious, suggested, or even implied by any of the prior art dolly platform attachments, either alone or in any combination thereof.

Still another object of the present invention is to provide a new platform attachment for a dolly for stabilizing and carrying heavy and large loads.

Still yet another object of the present invention is to provide a new platform attachment for a dolly that is easy and convenient to set up and use.

Even still another object of the present invention is to provide a new platform attachment for a dolly that easily converts a standard four-wheel dolly into a stable flatbed cart for carrying large and heavy objects.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a new platform attachment for a dolly according to the present invention.

FIG. 2 is a longitudinal cross-sectional view of the present invention.

### DESCRIPTION OF THE PREFERRED EMBODIMENT

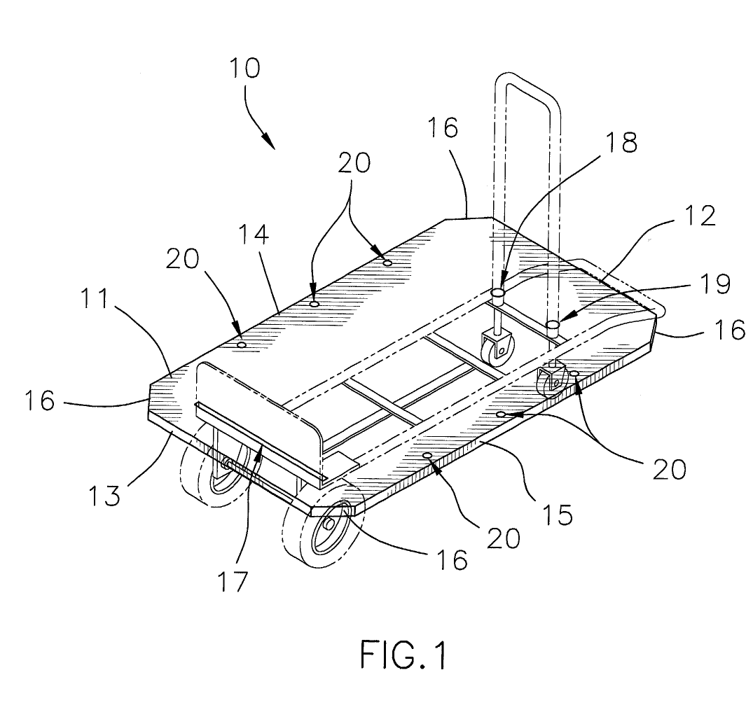

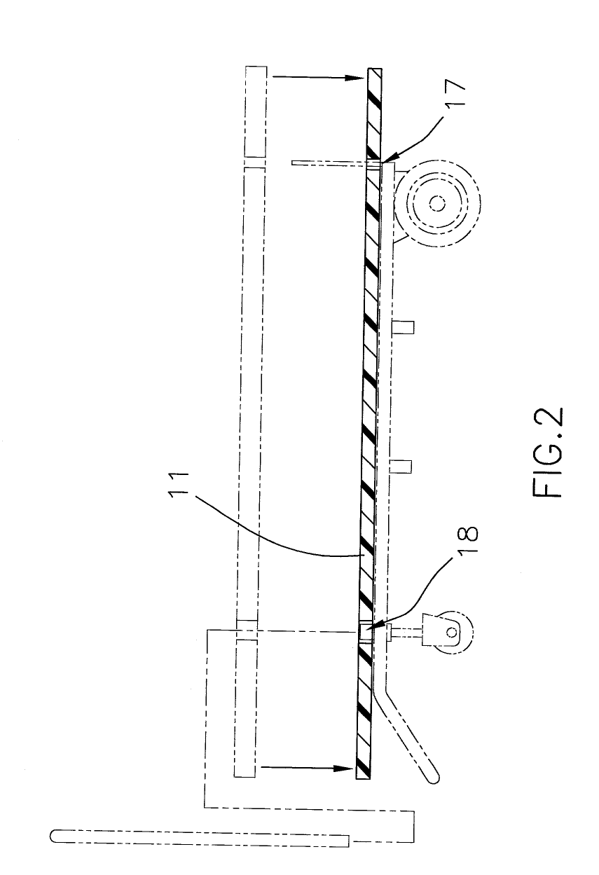

With reference now to the drawings, and in particular to FIGS. 1 through 2 thereof, a new platform attachment for a dolly embodying the principles and concepts of the present invention and generally designated by the reference numeral 10 will be described.

As best illustrated in FIGS. 1 through 2, the platform attachment for a dolly 10 generally comprises a board member 11 being adapted to mount upon a dolly, and being generally rectangular-shaped, and having a selected thickness, and also having first and second end edges 12,13 and longitudinal edges 14,15, and further having an elongate slot 17 being disposed therethrough near the second end edge 13 thereof and being adapted to receive a blade-like carry member of the dolly therethrough. The board member 11 further includes a pair of holes 18,19 being spacedly disposed therethrough near the first end edge 12 thereof and being adapted to receive portions of a handle of the dolly therethrough. The board member 11 also includes a plurality of apertures 20 being spacedly disposed therethrough and being aligned along the longitudinal edges 14,15 thereof and being adapted to receive bungee-like cords and straps therethrough for securing a load supported upon the board member 11. The board member 11 has corner edges 16 which are angled relative to the first and second end edges 12,13 and to the longitudinal edges 14,15 with the corner edges 16 being generally straight and having a selected length. The elongate slot 17 extends laterally and is centrally disposed between the longitudinal edges 14,15. The board member 11 has a width which is adapted to extend outwardly and overhang beyond a frame of the dolly. Each of the apertures 20 being disposed along one of the longitudinal edges 14 is aligned with a respective aperture 20 being disposed along the other of the longitudinal edges 15.

In use, the user positions the dolly upon its wheels and then places the board member 11 upon the dolly with the blade-like carry member of the dolly being received through the elongate slot 17, and the end portions of the handle of the dolly being received through the holes 18,19 of the board member 11. The user then places one's load upon the board member 11, and if need be, the user can place bungee-like cords and straps through the apertures 20 to safely secure the load upon the board member 11.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the platform attachment for a dolly. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A platform attachment for a dolly comprising:
a board member being adapted to mount upon a dolly, and being generally rectangular-shaped, and having a selected thickness, and also having first and second end edges and longitudinal edges, and further having an elongate slot being disposed therethrough near said second end edge thereof and being adapted to receive a blade-like carry member of the dolly therethrough.

2. A platform attachment for a dolly as described in claim 1, wherein said board member further includes a pair of holes being spacedly disposed therethrough near said first end edge thereof and being adapted to receive portions of a handle of the dolly therethrough.

3. A platform attachment for a dolly as described in claim 2, wherein said board member also includes a plurality of apertures being spacedly disposed therethrough an d being aligned along said longitudinal edges thereof and being adapted to receive bungee-like cords and straps therethrough for securing a load supported upon the board member.

4. A platform attachment for a dolly as described in claim 3, wherein said board member has corner edges which are angled relative to said first and second end edges and to said longitudinal edges, said corner edges being generally straight and having a selected length.

5. A platform attachment for a dolly as described in claim 4, wherein said elongate slot extends laterally and is centrally disposed between said longitudinal edges.

6. A platform attachment for a dolly as described in claim 5, wherein said board member has a width which is adapted to extend outwardly and overhang beyond a frame of the dolly.

7. A platform attachment for a dolly as described in claim 6, wherein each of said apertures disposed along one of said longitudinal edges is aligned with a respective said aperture disposed along the other of said longitudinal edges.
